(19) United States
(12) Patent Application Publication
(10) Pub. No.: US 2014/0148524 A1
(43) Pub. Date: May 29, 2014

(54) POLYURETHANE FOAM PANEL AND PRODUCTION METHOD FOR POLYURETHANE FOAM PANEL

(71) Applicants: Tsuguo Watanabe, Osaka-shi (JP); Jun Akai, Osaka-shi (JP)

(72) Inventors: Tsuguo Watanabe, Osaka-shi (JP); Jun Akai, Osaka-shi (JP)

(73) Assignee: TOYO TIRE & RUBBER CO., LTD., Osaka-shi, Osaka (JP)

(21) Appl. No.: 14/232,164

(22) PCT Filed: Jun. 12, 2012
(86) PCT No.: PCT/JP2012/064977

§ 371 Date: Jan. 10, 2014

(30) Foreign Application Priority Data
Jul. 19, 2011 (JP) 2011-157985
Feb. 2, 2012 (JP) 2012-021047
Mar. 8, 2012 (JP) 2012-051994

(51) Int. Cl. C08G 18/32; B29C 44/02

(52) U.S. Cl. CPC C08G 18/3203; B29C 44/02
USPC 521/174; 264/54

(57) ABSTRACT

A polyurethane foam panel, obtained by mixing a polyol composition comprising polyol compounds, and water as a blowing agent with a polyisocyanate component to react therewith, wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250, the water is contained in an amount of 20 to 100 parts by weight for 100 parts by weight of the polyol compounds, and the thickness direction of the polyurethane foam panel is substantially perpendicular to the foamed direction of cells in the foam or at the time of mixing and reacting the polyol composition and the polyisocyanate component with each other, the isocyanate index of the component is 30 or less.

### TECHNICAL FIELD

The present invention relates to a polyurethane foam panel obtained by using, as a raw material, a foaming stock-solution composition comprising not only a polyol composition comprising polyol compounds and water as a blowing agent, but also a polyisocyanate component, and having a low density and an excellent heat insulating performance. The present invention also relates to a method for producing the same.

### BACKGROUND ART

Hitherto, glass wool has widely been used as heat insulating material for detached houses and other buildings. Glass wool is not necessarily sufficient in heat insulating performance, but is inexpensive. This would be a reason why glass wool is widely used. On the other hand, polyurethane foam is better in heat insulating performance than glass wool. However, the foam is expensive and therefore not as widely used as glass wool is.

It is conceivable for lowering the price of polyurethane foam that the foam is lowered in density while the heat insulating performance thereof is being maintained. Patent Document 1 listed below states that a low-density polyurethane foam having a core density of 2 to 20 kg/m³ both inclusive is produced in a spraying manner using, as a raw material, a polyol composition comprising a polyoxyalkylene polyether polyol having a number-average molecular weight of 2000 to 9000, and a polyoxyalkylene polyether polyol having a number-average molecular weight of 250 to 750. However, when the polyol composition described in this document is used as the raw material, a limitation is imposed in lowering the density of the foam, considering cell roughness (poorness in the appearance of the foam), brittleness (fragileness of the foam), and others. The polyurethane foam described in this document is conceived to be used for being sprayed; thus, it is important for the foam to have a low recovery percentage. Thus, the foam is poor in flexibility.

Patent Document 2 listed below states that a low-density polyurethane foam having a core density of 5 to 14 kg/m³ both inclusive is produced by continuous slab foaming using, as raw materials, a polyether polyol having an average functional group number of 2.5 to 4 and a hydroxyl value of 200 to 300 mgKOH/g, a polyether polyol having an average functional group number of 4 to 6 and a hydroxyl value of 400 to 900 mgKOH/g, a polyether polyol having an average functional group number of 2.5 to 3.5 and a hydroxyl value of 20 to 60 mgKOH/g, and a polyol composition. However, about the polyurethane foam described in this document also, a limitation is imposed in lowering the density of the foam, considering cell roughness (poorness in the appearance of the foam), brittleness (fragileness of the foam), and others.

Patent Document 3 listed below describes a method for producing an interconnected-cell polyurethane foam, using a mixture of (a) a polyoxyalkylene polyol having 2 to 3.5 functional groups, a hydroxyl value of 28 to 90 mgKOH/g, and a polyoxyethylene unit content by percentage of 5% or less by weight, (b) a polyoxyalkylene polyol having 3 to 6 functional groups and a hydroxyl value of 150 to 500 mgKOH/g and (c) a polyol having 2 to 3 functional groups and a hydroxyl value of 450 to 840 mgKOH/g, and water as a blowing agent in an amount of 6 to 12 parts by weight for 100 parts by weight of the mixture of the polyols. However, in this production method, the lower limit of the density of the foam is specified from the viewpoint of the strength of the foam. Thus, a limitation is imposed in lowering the density of the foam.

Apart from the above, when a polyurethane foam panel is lowered in density, it is important to lower the closed-cell proportion of cells in its foam to heighten the proportion of interconnected-cells therein. However, the present inventions of the patent documents are inventions in which attention is paid only to the formulation of their polyol composition. Thus, about, for example, the shape of a low-density polyurethane foam panel, or the production process thereof, attempts for heightening the heat insulating performance of the foam are not made in the present inventions of the patent documents.

### PRIOR ART DOCUMENTS

### Patent Documents

Patent Document 1: JP-A-2002-293868
Patent Document 2: Japanese Patent No. 4079254
Patent Document 3: JP-A-06-25375

### SUMMARY OF THE INVENTION

### Problems to be Solved by the Invention

In light of the above-mentioned actual situation, the present invention has been made, and an object thereof is to provide a polyurethane foam panel having a low density and an excellent heat insulating performance and being useful as heat insulating material for detached houses and other buildings, and to provide a method the polyurethane foam panel.

### Means for Solving the Problems

In order to solve the problems, the present inventors have made eager investigations about the formulation of a polyol composition as a raw material, and found out that when a polyurethane foam panel is used as a heat insulating material, the heat insulating performance thereof can be most efficiently heightened by making the thickness direction of the polyurethane foam panel substantially perpendicular to the foamed direction in cells therein.

The present inventors have further made eager investigations about a method for solving the problems to find out that by contriving the formulation of the polyol composition as a raw material, and the isocyanate index (NCO index) of a polyisocyanate component when the polyol composition is mixed with the polyisocyanate component to react therewith, a polyurethane foam panel can be obtained which is low in density while not fragile (brittle) about its foam, and further which has an excellent flexibility and heat insulating performance. The present inventors have further found out that when the polyurethane foam panel is used as a heat insulating material, the heat insulating performance thereof can be most effectively heightened by making the thickness direction of the panel substantially perpendicular to the foamed directions of cells therein. On the basis of these findings, the present invention has been achieved, and is as follows.

This object can be attained by the present invention, which is an invention as described below. The present invention is a polyurethane foam panel, obtained by mixing a polyol composition comprising polyol compounds, and water as a blowing agent with a polyisocyanate component to react therewith, wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250, the water is contained in an amount of 20 to 100 parts by weight for 100 parts by weight of the polyol compounds, and the thickness direction of the polyurethane foam panel is substantially perpendicular to the foamed direction of cells in the foam.

The polyol composition contains 20 to 100 parts by weight of water as a blowing agent. Thus, when this polyol composition is used as a raw material, a low-density polyurethane foam panel can be produced.

Incidentally, in the case of a polyol composition containing only a polyether polyol having a high molecular weight as a polyol compound, the resin is insufficient in strength at the blowing stage into a foam by increasing the blend proportion of water in the polyol composition. Thus, blowing gas inside the foam is released off in a large quantity so that the foam is easily shrunken. As a result, the density of the foam tends to be insufficiently lowered. However, the polyol composition (of the present invention) contains the short glycol (B), the molecular weight of which is less than 250, together with the high-molecular-weight polyether polyol (A); thus, at the initial blowing stage into a foam, the composition is increased in viscosity-increasing rate (resinification rate). According to this increase, the foam is heightened in recovery percentage by effect of the high-molecular-weight polyether polyol (A) and further the foam is heightened in resin strength from the initial blowing stage into the foam by effect of the low-molecular-weight short glycol (B). As a result, a polyurethane foam panel low in density and excellent in flexibility can be produced.

Furthermore, the foam has a small cell diameter even when made low in density because the polyol composition contains the high-molecular-weight polyether polyol (A) and the low-molecular-weight short glycol (B). As a result, the foam can be prevented from undergoing cell roughness (poorness in the appearance of the foam) and further restrained from becoming fragile to be made low in brittleness.

As described above, the polyurethane foam panel according to the present invention is low in density. The cells in the foam are each in a substantially elliptic form. Plural ones out of the cells are continuous to each other so that the foam has a high interconnected-cell proportion and a specific foamed direction. About this polyurethane foam panel, the thickness direction thereof is substantially perpendicular to the foamed direction of the cells in the foam, so that the shift of heat can be restrained in the thickness direction. Consequently, when the polyurethane foam panel is arranged in a building such as a detached house, high heat insulating performance is achieved, particularly, in the thickness direction.

The present invention is also a polyurethane foam panel, obtained by mixing a polyol composition comprising polyol compounds, and water as a blowing agent with a polyisocyanate component to react therewith, wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250, the water is contained in an amount of 20 to 100 parts by weight for 100 parts by weight of the polyol compounds, and at the time of mixing and reacting the polyol composition and the polyisocyanate component with each other, the isocyanate index of the component is 30 or less.

The polyol composition contains 20 to 100 parts by weight of water as a blowing agent. Thus, when this polyol composition is used as a raw material, a low-density polyurethane foam panel can be produced.

Incidentally, in the case of a polyol composition containing only a polyether polyol having a high molecular weight as a polyol compound, the resin is insufficient in strength at the blowing stage into a foam by increasing the blend proportion of water in the polyol composition. Thus, blowing gas inside the foam is released off in a large quantity so that the foam is easily shrunken. As a result, the density of the foam tends to be insufficiently lowered. However, the polyol composition (of the present invention) contains the short glycol (B), the molecular weight of which is less than 250, together with the high-molecular-weight polyether polyol (A); thus, at the initial blowing stage into a foam, the composition is increased in viscosity-increasing rate (resinification rate). According to this increase, the foam is heightened in recovery percentage by effect of the high-molecular-weight polyether polyol (A) and further the foam is heightened in resin strength from the initial blowing stage into the foam by effect of the low-molecular-weight short glycol (B). As a result, a polyurethane foam panel low in density and excellent in flexibility can be produced.

Furthermore, the foam has a small cell diameter even when made low in density because the polyol composition contains the high-molecular-weight polyether polyol (A) and the low-molecular-weight short glycol (B). As a result, the foam can be prevented from undergoing cell roughness (poorness in the appearance of the foam) and further restrained from becoming fragile to be made low in brittleness.

About the polyurethane foam panel according to the present invention, the specific polyol composition is used, and further the isocyanate index is 30 or less at the time of mixing and reacting the polyol composition and the polyisocyanate component with each other; thus, the panel has an excellent flexibility. Consequently, when work is made to fit the polyurethane foam panel into a predetermined shape, for example, between columns, the panel is easily fitted. Thus, the polyurethane foam panel is excellent in fitting workability.

In the polyurethane foam panel, it is preferred that the thickness direction of the polyurethane foam panel is substantially perpendicular to the foamed direction of the cells in the foam. As described above, the polyurethane foam panel according to the present invention is low in density; the cells in the foam are each in a substantially elliptic form; and plural ones out of the cells are continuous to each other so that the interconnected-cell proportion is high. When the polyurethane foam panel further has a thickness direction substantially perpendicular to the foamed direction in the cells in the foam, the shift of heat in the thickness direction can be restrained. Consequently, when the polyurethane foam panel is arranged in a building such as a detached house, high heat insulating performance is achieved, particularly, in the thickness direction.

In the polyurethane foam panel, it is preferred that the polyol compounds contain the polyether polyol (A) in an amount of 10 to 80 parts by weight for 100 parts by weight of the polyol compounds, and the short glycol (B) in an amount of 10 to 60 parts by weight therefor. This embodiment makes it possible to heighten the foam in recovery percentage and make the foam small in cell diameter while raising the foam in resin strength. As a result, the polyurethane foam panel can be improved in brittleness and flexibility with a better balance while lowered in density.

In the polyurethane foam panel, it is preferred that the polyol compounds further comprise a polyether polyol (C) which is a polymer made from propylene oxide and has an average functional group number of 2 to 4 and a weight-average molecular weight of 3000 to 5000. When the polyol compounds comprise, as one thereof, the polyether polyol (C), which is a polymer made from propylene oxide and has a high molecular weight, the membrane of the cells in the foam is broken at a late blowing stage into the foam, so that an interconnected-cell polyurethane foam panel is easily formed. As a result, the foam can be lowered in density with a higher certainty while restrained in foam shrinkage and other damages.

The method according to the present invention for producing a polyurethane foam panel is a polyurethane foam panel producing method using, as a raw material, a foaming stock-solution composition comprising not only a polyol composition comprising polyol compounds and water as a blowing agent, but also a polyisocyanate component, the method including an injecting step of injecting the foaming stock-solution composition into a mold having a longitudinal direction, a width direction and a thickness direction to locate the bottom surface of the foaming stock-solution composition onto side surfaces of the mold that extend in the longitudinal and thickness directions, and further including, after the injecting step, a reaction step of causing the foaming stock-solution composition to undergo reaction, wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250, and the water is contained in an amount of 20 to 100 parts by weight for 100 parts by weight of the polyol compounds. According to this production method, the thickness direction of the polyurethane foam panel is substantially perpendicular to the foamed direction of cells in the foam, and thus the polyurethane foam panel can be efficiently produced with an excellent heat insulating performance in the thickness direction.

Another method according to the present invention for producing a polyurethane foam panel is a polyurethane foam panel producing method using, as a raw material, a foaming stock-solution composition comprising not only a polyol composition comprising polyol compounds and water as a blowing agent, but also a polyisocyanate component, wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250, the water is contained in an amount of 20 to 100 parts by weight for 100 parts by weight of the polyol compounds, and at the time of mixing and reacting the polyol composition and the polyisocyanate component with each other, the isocyanate index of the component is 30 or less. According to this production method, the polyurethane foam panel can be produced to have a low density and further an excellent flexibility and heat insulating performance.

The polyurethane foam panel producing method preferably includes an injecting step of injecting the foaming stock-solution composition into a mold having a longitudinal direction, a width direction and a thickness direction to locate the bottom surface of the foaming stock-solution composition onto side surfaces of the mold that extend in the longitudinal and thickness directions, and further includes, after the injecting step, a reaction step of causing the foaming stock-solution composition to undergo reaction. According to this production method, the thickness direction of the polyurethane foam panel is substantially perpendicular to the foamed direction of cells in the foam, and thus the polyurethane foam panel can be efficiently produced with an excellent heat insulating performance in the thickness direction.

In each of the polyurethane foam panel producing methods, it is preferred that the polyol compounds contain the polyether polyol (A) in an amount of 10 to 80 parts by weight for 100 parts by weight of the polyol compounds, and the short glycol (B) in an amount of 10 to 60 parts by weight therefor.

In each of the polyurethane foam panel producing methods, it is preferred that the polyol compounds further comprise a polyether polyol (C) which is a polymer made from propylene oxide and has an average functional group number of 2 to 4 and a weight-average molecular weight of 3000 to 5000.

### BRIEF DESCRIPTION OF THE DRAWINGS

FIG. 1 is a view illustrating an example of a conventional method for producing a polyurethane foam panel.

FIG. 2 is a view illustrating an example of the method of the present invention for producing a polyurethane foam panel.

### MODE FOR CARRYING OUT THE INVENTION

The polyol composition for a polyurethane foam panel according to the present invention contains, as its polyol compounds, a polyether polyol (A) which is a polymer made from an alkylene oxide and has an average functional group number of 2 to 4 and a weight-average molecular weight of 3000 to 8000, and a short glycol (B) having a molecular weight less than 250.

The polyether polyol (A) is a polyoxyalkylene polyol obtained by causing an alkylene oxide to ring-opening-addition polymerize with an initiator having 2 to 4 active hydrogen atoms. Specific examples of the initiator include aliphatic polyhydric alcohols (for example, glycols such as ethylene glycol, propylene glycol, diethylene glycol, dipropylene glycol, 1,4-butanediol, 1,3-butanediol, 1,6-hexanediol, neopentyl glycol, cyclohexylene glycol, cyclohexanedimethanol and the like, triols such as trimethylolpropane, glycerin and the like, and tetra-functional alcohols such as pentaerythritol and the like; aliphatic amines (for example, alkylenediamines such as ethylenediamine, propylenediamine, butylenediamine, hexamethylenediamine, neopentyldiamine and the like, and alkanolamines such as monoethanolamine, diethanolamine and the like); aromatic amines (for example, 2,4-toluenediamine, 2,6-toluenediamine, diethyltoluenediamine, 4,4′-diaminodiphenylmethane, p-phenylenediamine, o-phenylenediamine, naphthalenediamine and the like). These may be used alone or in any combination of two or more thereof. The initiator to be used is preferably aliphatic alcohols, more preferably triols, particularly preferably glycerin. The average functional group number of the polyether polyol (A) is 2 to 4, more preferably 2.5 to 3.5. Further, the weight-average molecular weight of the polyether polyol (A) is more preferably 3000 to 5000.

Examples of the alkylene oxide include ethylene oxide, propylene oxide, 1,2-butylene oxide, 2,3-butylene oxide, styrene oxide, cyclohexene oxide and the like. It is preferred to use ethylene oxide and propylene oxide, out of these examples, together to ring-opening-addition polymerize with the initiator. At this time, it is preferred to set the proportion of ethylene oxide (the proportion “ethylene oxide”/“ethylene oxide+propylene oxide”) into the range of 5 to 30%.

The hydroxyl value of the polyether polyol (A) is preferably 20 to 100 mgKOH/g, more preferably 30 to 60 mgKOH/g. If the hydroxyl value is less than 20 mgKOH/g, the ratio of the viscosity of the polyol composition to that of the polyisocyanate component is high so that these are insufficiently stirred at the time of the mixing. Contrarily, if the value is more than 100 mgKOH/g, it is difficult that the resultant polyurethane foam gains an appropriate toughness. The hydroxyl value is a value measured in accordance with JIS K1557-1:2007.

Examples of the short glycol (B), the molecular weight of which is less than 250, include ethylene glycol (molecular weight: 62), propylene glycol (molecular weight: 76), diethylene glycol (molecular weight: 106), dipropylene glycol (molecular weight: 134), 1,4-butanediol (molecular weight: 90), 1,3-butanediol (molecular weight: 90), 1,6-hexanediol (molecular weight: 118), glycerin (molecular weight: 92), tripropylene glycol (molecular weight: 192) and the like. Of these examples, diethylene glycol, dipropylene glycol and glycerin are preferred and diethylene glycol is particularly preferred in order to heighten the resin strength of the foam with a higher certainty. The molecular weight of the short glycol (B) is preferably from 62 to 200, more preferably from 90 to 150.

It is preferred that the polyol composition for a polyurethane foam according to the present invention further contains, as one of the polyol compounds, a polyether polyol (C) which is a polymer made from propylene oxide and has an average functional group number of 2 to 4 and a weight-average molecular weight of 3000 to 5000. The polyether polyol (C) is a polyoxyalkylene polyol obtained by causing only propylene oxide to ring-opening-addition polymerize with an initiator having 2 to 4 active hydrogen atoms. The initiator is not particularly limited, and examples thereof include above-mentioned aliphatic polyhydric alcohols, aliphatic amines, and aromatic amines. The initiator is particularly preferably glycerin.

In order to produce a polyurethane foam panel which gives an excellent heat insulating performance while lowered in density, the polyol composition according to the present invention preferably contains the polyether polyol (A) in an amount of 10 to 80 parts by weight for 100 parts by weight of the polyol compounds, and the short glycol (B) in an amount of 10 to 60 parts by weight therefor, and more preferably contains the polyether polyol (A) in an amount of 15 to 70 parts by weight therefor and the short glycol (B) in an amount of 10 to 50 parts by weight therefor. When the composition contains the polyether polyol (C), the composition preferably contains the polyether polyol (A), the short glycol (B), and the polyether polyol (C) in respective amounts of 10 to 30 parts by weight, 10 to 60 parts by weight and 30 to 70 parts by weight therefor, and more preferably contains the components (A), (B) and (C) in respective amounts of 15 to 25 parts by weight, 10 to 50 parts by weight and 40 to 60 parts by weight therefor.

Water is blended as a blowing agent into the polyol composition according to the present invention. The blowing agent is preferably water alone. The blend amount thereof is 20 to 100 parts by weight, more preferably 30 to 90 parts by weight, even more preferably 40 to 80 parts by weight for 100 parts by weight of the polyol compounds. The blend of water in such a large amount makes it possible to lower the density of the polyurethane foam.

The core density of the polyurethane foam panel according to the present invention is preferably 20 kg/m³ or less, more preferably 15 kg/m³ or less, even more preferably 12 kg/m³ or less. This foam density can be set within the range, for example, by adjusting the amount of water as a blowing agent within the range of 20 to 100 parts by weight (for 100 parts by weight of the polyol compounds). The foam density is a value measured according to JIS K7222.

Usually, a flame retardant, a catalyst and a foam stabilizer are further blended into the polyol composition according to the present invention. Various additives may further be blended thereinto which are blendable into any polyol composition for a polyurethane foam. Examples thereof include a colorant and an antioxidant.

Examples of the flame retardant include organic phosphates, halogen-containing compounds, and metal compounds such as aluminum hydroxide. Organic phosphates are particularly preferred since these compounds have an effect of lowering the viscosity of the polyol composition. Examples of the organic phosphates include halogenated alkyl esters of phosphoric acid, alkyl phosphates, aryl phosphates, and phosphonates. Specific examples thereof include tris(chloropropyl)phosphate (TMCPP, manufactured by Daihachi Chemical Industry Co., Ltd.), tributoxyethyl phosphate (TBEP), tributyl phosphate, triethyl phosphate, trimethyl phosphate, and cresylphenyl phosphate. The blend amount of the flame retardant is preferably 10 to 50 parts by weight, more preferably 15 to 40 parts by weight for 100 parts by weight of the polyol compounds. It is particularly preferred that the polyol composition contains, besides the polyether polyol (A) and the short glycol (B), the flame retardant in an amount of 20 parts or more by weight for 100 parts by weight of the polyol compounds since the foam can be prevented from being worse in brittleness.

The catalyst is not particularly limited as far as the catalyst promotes the urethanating reaction. The catalyst is preferably a reactive amine catalyst which can react with isocyanate groups of the polyisocyanate component. Examples of such an reactive amine catalyst include N,N-dimethylethanolamine, N,N-dimethylaminoethoxyethanol, N,N,N′-trimethylaminoethylethanolamine, N,N,N′,N′-tetramethyl-2-hydroxypropylenediamine, N-hydroxyethylmorpholine, N-methyl-N-hydroxyethylpiperazine, N,N-dimethylpropylenediamine and the like.

An ordinary tertiary amine catalyst is also usable. Examples of the tertiary amine catalyst include N,N,N′,N′-tetramethylethylenedimaine, N,N,N′,N′-tetramethylhexamethylenediamine, N,N,N′,N′,N″-pentamethyldiethylenetriamine, diazabicycloundecene, N,N-dimethylcyclohexylamine, triethylenediamine, N-methylmorpholine and the like.

The blend amount of the catalyst is preferably 2 to 10 parts by weight, more preferably 3 to 8 parts by weight for 100 parts by weight of the polyol compounds.

The foam stabilizer may be, out of known foam stabilizers for polyurethane foams, for example, a graft copolymer of a polyoxyalkylene glycol, which is a polymer made from ethylene oxide or propylene oxide, and polydimethylsiloxane. The foam stabilizer is preferably a silicone foam stabilizer wherein the oxyethylene group content by percentage in a polyoxyalkylene is 70 to 100% by mole. Specific examples thereof include products SH-193, SZ-1671, SF-2937F, and SF-2938F (manufactured by Dow Corning Toray Co., Ltd.); products B-8465, B-8467 and B-8481 (manufactured by Evonik Degussa Japan Co., Ltd.); a product L-6900 (manufactured by Momentive) and the like. The blend amount of the foam stabilizer is preferably 1 to 10 parts by weight for 100 parts by weight of the polyol compounds.

The polyisocyanate component, which is mixed with the polyol composition to react with each other to form a polyurethane foam panel, may be various types of polyisocyanate compounds having two or more isocyanate groups, such as aromatic types, alicyclic types, aliphatic types and the like. The polyisocyanate component is preferably diphenylmethane diisocyanate (MDI) in a liquid form since the component is easy to handle, is fast in reaction rate, gives a polyurethane foam excellent in physical properties, is low in costs, and provides other advantages. Examples of liquid-form MDI include crude MDIs (c-MDIs) (such as products 44V-10 and 44V-20 (manufactured by Sumika Bayer Urethane Co., Ltd.), a product MILLIONATE MR-200 (Nippon Polyurethane Industry Co., Ltd.), and urethonimine-containing MDI (a product, MILLIONATE MTL, manufactured by Nippon Polyurethane Industry Co., Ltd.). Together with liquid-form MDI, a different polyisocyanate compound may be used. The polyisocyanate compound used together may be any known polyisocyanate compound in the technical field of polyurethane.

In the polyurethane foam panel according to the present invention, at the time of mixing and reacting the polyol composition and the polyisocyanate component with each other, the isocyanate index (NCO index) of the component is set preferably to 30 or less, more preferably to less than 30. The lower limit of the isocyanate index may be, for example, 20. When the isocyanate index is set into the range, the polyurethane foam panel can be produced to have a low density, and an especially excellent flexibility and heat insulating performance. The isocyanate index denotes, on percentage, the proportion by equivalent of isocyanate groups of the polyisocyanate component to all active hydrogen groups (about water as a blowing agent, a calculation is made on the supposition that water is a bifunctional active hydrogen compound) contained in the polyol composition (the ratio of the equivalents of the isocyanate groups to 100 equivalents of the active hydrogen groups).

In the polyurethane foam panel according to the present invention, it is preferred that the thickness direction of the polyurethane foam panel is substantially perpendicular to the foamed direction of cells in its foam. In the present invention, an angle represented by the wording “substantially perpendicular” specifically means 90°±15°, in particular, 90°±10°. The wording “foamed direction of cells in the foam” means, when the shapes of the individual cells are regarded as elliptic shapes, the major axis direction thereof, in particular, the direction when the cells are measured in their central region in the width direction (region extending from their center in the width direction to each of their both sides by about 10% of their width direction length).

A polyurethane foam panel according to the present invention can be produced by the following method:

a method for producing a polyurethane foam panel, using, as a raw material, a foaming stock-solution composition comprising not only a polyol composition comprising polyol compounds and water as a blowing agent, but also a polyisocyanate component, the method including an injecting step of injecting the foaming stock-solution composition into a mold having a longitudinal direction, a width direction and a thickness direction to locate the bottom surface of the foaming stock-solution composition onto side surfaces of the mold that extend in the longitudinal and thickness directions, and further including, after the injecting step, a reaction step of causing the foaming stock-solution composition to undergo reaction, wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250, and the water is contained in an amount of 20 to 100 parts by weight for 100 parts by weight of the polyol compounds.

In this production method, at the time of mixing and reacting the polyol composition and the polyisocyanate component with each other, the isocyanate index (NCO index) is preferably from 30 to 100, more preferably from 40 to 70. By setting the isocyanate index within the range, the foam can be prevented from being worse in brittleness even when made low in density. The isocyanate index denotes, on percentage, the proportion by equivalent of isocyanate groups of the polyisocyanate component to all active hydrogen groups (about water as a blowing agent, a calculation is made on the supposition that water is a bifunctional active hydrogen compound) contained in the polyol composition (the ratio of the equivalents of the isocyanate groups to 100 equivalents of the active hydrogen groups).

In the polyurethane foam panel produced by this production method, the closed-cell proportion is preferably 15% or less, more preferably 0 to 10%. By making the interconnected-cell proportion high as above, the resultant polyurethane foam can ensure an excellent dimension stability. The closed-cell proportion is a value measured according to ASTM D2856.

About the polyurethane foam panel obtained by this production method, the thermal conductivity λ preferably satisfies the following: λ0.04 W/m·K. In this case, the polyurethane foam can exhibit a sufficient heat insulating performance even when the foam has been lowered in density. The thermal conductivity is a value measured according to JIS A1412-2.

Another polyurethane foam panel according to the present invention can be produced by the following production method:

a method for producing a polyurethane foam panel, using, as a raw material, a foaming stock-solution composition comprising not only a polyol composition comprising polyol compounds and water as a blowing agent, but also a polyisocyanate component, wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250, the water is contained in an amount of 20 to 100 parts by weight for 100 parts by weight of the polyol compounds, and at the time of mixing and reacting the polyol composition and the polyisocyanate component with each other, the isocyanate index of the component is 30 or less. In order to produce the polyurethane foam panel to have a thickness direction substantially perpendicular to the foamed direction in cells in the foam, the production method preferably includes an injecting step of injecting the foaming stock-solution composition into a mold having a longitudinal direction, a width direction and a thickness direction to locate the bottom surface of the foaming stock-solution composition onto side surfaces of the mold that extend in the longitudinal and thickness directions, and further includes, after the injecting step, a reaction step of causing the foaming stock-solution composition to undergo reaction.

In the polyurethane foam panel produced by this production method, the closed-cell proportion is preferably 15% or less, more preferably 0 to 10%. By making the interconnected-cell proportion high as above, the resultant polyurethane foam can ensure an excellent dimension stability. The closed-cell proportion is a value measured according to ASTM D2856.

About the polyurethane foam panel produced by this production method, the thermal conductivity λ preferably satisfies the following: λ0.04 W/m·K. In this case, the polyurethane foam can exhibit a sufficient heat insulating performance even when the foam has been lowered in density. The thermal conductivity is a value measured according to JIS A1412-2.

As illustrated in FIG. 2, in a conventional polyurethane foam panel producing method, a surface material 3 is wound off from an original roll thereof to be supplied, and simultaneously, a foaming stock-solution composition containing a polyol composition and a polyisocyanate component is injected onto the surface material 3 from a mixing head 1 (injecting step). After the injecting step, while the foaming stock-solution composition is covered with another surface material (rear surface material) 4, the foaming stock-solution composition is caused to undergo reaction (reaction step). As a result, a polyurethane foam panel is obtained which has a foamed direction parallel to the thickness direction. When the polyurethane foam panel is, particularly, low in density, its individual cells are interconnected cells so that the shift of heat is large in the foamed direction, and accordingly the heat insulating performance tends to be lowered. Consequently, the conventional polyurethane foam panel producing method tends to cause the panel to be deteriorated in heat insulating performance in the thickness direction.

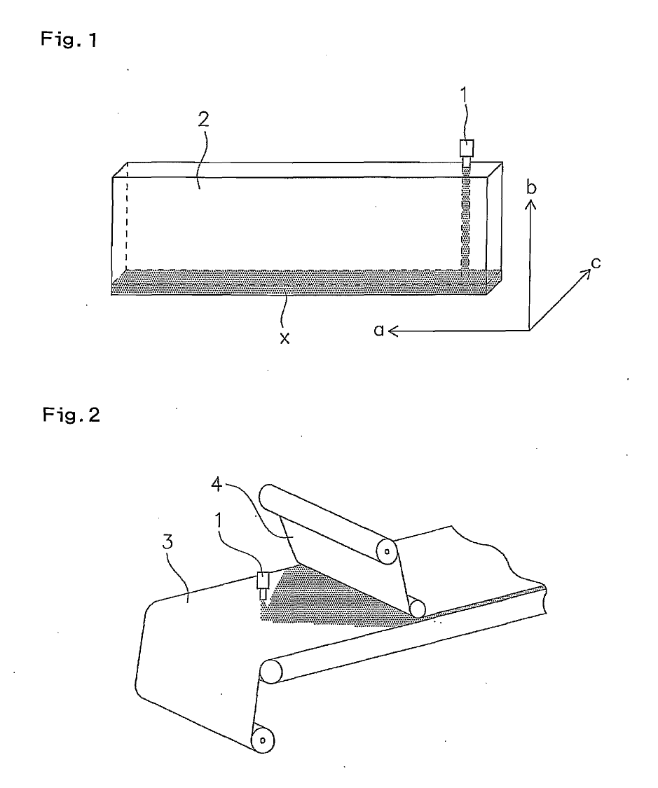

In the polyurethane foam panel producing method according to the present invention, which is different from the above, the following is preferably performed as illustrated in, for example, FIG. 1: a foaming stock-solution composition containing a polyol composition and a polyisocyanate component is injected from a mixing head 1 into a mold 2 having a longitudinal direction a, a width direction b and a thickness direction c to locate a bottom surface X of the foaming stock-solution composition onto side surfaces of the mold that extend to the longitudinal direction a and the thickness direction c (injecting step). After the injection, while the foaming stock-solution composition reacts to be foamed in the width direction b (to swell), a foam is formed (reaction step). As a result, a polyurethane foam panel is obtained wherein the foamed direction (width direction b) is substantially perpendicular to the thickness direction c. In the reaction step, the mold may be wholly or locally heated if necessary.

### EXAMPLES

Hereinafter, the present invention will be described in more detail by way of examples. However, the present invention is not limited to these examples.

### (Preparation of Polyol Compositions)

Polyol compositions were each prepared in accordance with a blend composition described in Table 1. Details of individual components in Table 1 are as follows:

(1) Polyol Compounds

Polyether polyol (A)-1: trade name “EXCENOL-820” (manufactured by Asahi Glass Co., Ltd.), which is a polyether polyol (weight-average molecular weight=4900, and hydroxyl value (OHV)=34 mgKOH/g) obtained by using glycerin as an initiator and addition-polymerizing ethylene oxide and propylene oxide thereto.

Polyether polyol (A)-2: trade name “EXCENOL-230” (manufactured by Asahi Glass Co., Ltd.), which is a polyether polyol (weight-average molecular weight=3000, and hydroxyl value (OHV)=56 mgKOH/g) obtained by using glycerin as an initiator and addition-polymerizing ethylene oxide and propylene oxide thereto.

Polyether polyol (A)-3: trade name “EXCENOL-851” (manufactured by Asahi Glass Co., Ltd.), which is a polyether polyol (weight-average molecular weight=7000, and hydroxyl value (OHV)=25 mgKOH/g) obtained by using glycerin as an initiator and addition-polymerizing ethylene oxide and propylene oxide thereto.

Short glycol (B)-1: diethylene glycol (DEG) (molecular weight=106, and hydroxyl value (OHV)=1058 mgKOH/g, manufactured by Nacalai Tesque, Inc.)

Short glycol (B)-2: glycerin (Gly) (molecular weight=92, and hydroxyl value (OHV)=1829 mgKOH/g, manufactured by Nacalai Tesque, Inc.)

Polyether polyol (C): trade name “T-3000S” (manufactured by Mitsui Chemicals, Inc.), which is a polyether polyol (weight-average molecular weight=3000, and hydroxyl value=56 mgKOH/g) obtained by using glycerin as an initiator and addition-polymerizing only propylene oxide thereto.

(2) Flame retardant: trade name “TMCPP” (manufactured by Daihachi Chemical Industry Co., Ltd.)

(3) Foam stabilizer: silicone type nonionic surfactant, trade name “SF-2938F” (manufactured by Dow Corning Toray Co., Ltd.)

(4) Catalysts

Catalyst-1: tertiary amine catalyst, trade name “TOYOCAT-ET” (manufactured by Tosoh Corporation)

Catalyst-2: N,N-dimethylaminoethoxyethanol, trade name “KAO No. 26” (manufactured by Kao Corporation)

### (Panel Evaluation)

### Examples 1 and 2

A foaming stock-solution composition was prepared (in each of these examples). This contained a polyol composition adjusted into a formulation shown in Table 1, and a polyisocyanate component (c-MDI (“Sumidur 44V-10”, manufactured by Sumika Bayer Urethane Co., Ltd.; NCO %: 31%) was used, and the isocyanate index (NCO index) is shown in Table 1). The foaming stock-solution composition was injected to the bottom surface X of the mold (longitudinal-direction-a-length: 1820 mm, width-direction-b-length: 400 mm, and thickness-direction-c-length: 100 mm) illustrated in FIG. 1 from the mixing head 1. Thereafter, the foaming stock-solution composition was caused to undergo reaction to produce a polyurethane foam panel having substantially the same shape as the internal space of the mold, and having a thickness direction substantially perpendicular (90°) to the foamed direction of cells in the foam. Results are shown in Table 1.

### Comparative Example 1

A polyurethane foam panel was produced in the same way as in Example 1 except that the polyol composition used in Example 1 was changed to a polyol composition in Table 1. The thickness direction of the panel and the foamed direction of cells in the foam were the same as in Example 1 (substantially perpendicular (90°) to each other). Results are shown in Table 1.

### Comparative Example 2

A foaming stock-solution composition was prepared which contained a polyol composition adjusted into a formulation shown in Table 1, and a polyisocyanate component (c-MDI (“Sumidur 44V-10”, manufactured by Sumika Bayer Urethane Co., Ltd.; NCO %: 31%) was used, and the isocyanate index (NCO index) is shown in Table 1). The foaming stock-solution composition was injected onto the surface material 3 illustrated in FIG. 2 from the mixing head 1. Thereafter, the foaming stock-solution composition was caused to undergo reaction, and the resultant was cut in the width direction to produce a polyurethane foam panel having the same shape as the polyurethane foam panel of Example 1, and having a thickness direction substantially parallel (0 to 30°) to the foamed direction of cells in the foam. Results are shown in Table 1.

### [Weight-Average Molecular Weight]

The foam was measured about the weight-average molecular weight thereof, using GPC (gel permeation chromatography), to give a value in terms of standard polystyrene.

GPC instrument: LC-10A, manufactured by Shimadzu Corporation

Columns: the following three columns were connected to each other, and the resultant was used: “PLgel, 5 μm, 500 Å”, “PLgel, 5 μm, 100 Å” and “PLgel, 5 μm, 50 Å”, manufactured by Polymer Laboratories Ltd.

Flow rate: 1.0 mL/min

Concentration: 1.0 g/L

Injection volume: 40 μL

Column temperature: 40° C.

Eluent: tetrahydrofuran

### [Foam Density]

The foam density was analyzed according to JIS K 7222.

### [Thermal Conductivity]

The thermal conductivity was measured according to JIS A1412-2 (Method for Measuring Thermal Resistance and Thermal Conductivity of Thermal Insulating Material; Section 2: Heat Flow Meter Method) (HFM method) on the basis of JIS A9526

### (Sprayed Rigid Polyurethane Foam for Building-Heat-Insulation).

### [Foam Appearance]

About the produced polyurethane foam, the appearance of its core region was evaluated with the naked eye. When the foam was fine in cell diameter, particularly good in foamed state and very low in brittleness, the foam was judged to be good (circular sign: ◯). When the foam was coarse in cell diameter, bad in foamed state and high in brittleness, the foam was judged to be bad (cross sign: X).

TABLE 1

| | OHV | | | Comparative | Comparative |
|---|---|---|---|---|---|
| Blend agents | (mgKOH/g) | Example 1 | Example 2 | Example 1 | Example 2 |
| Polyether polyol (A)-1 | 34 | — | — | 20 | — |
| Polyether polyol (A)-2 | 56 | 20 | — | — | 20 |
| Polyether polyol (A)-3 | 25 | | 30 | | |
| Polyether polyol (C) | 56 | 50 | 40 | 80 | 50 |
| Short glycol (B)-1 (DEG) | 1058 | 30 | 30 | — | 30 |
| Flame retardant | | 30 | 30 | 30 | 30 |
| Foam stabilizer-1 | | 5.0 | 5.0 | 5.0 | 5.0 |
| Catalyst-1 | | 4.0 | 4.0 | 4.0 | 4.0 |
| Catalyst-2 | | 2.0 | 2.0 | 2.0 | 2.0 |
| Water | | 40.0 | 40.0 | 40.0 | 40.0 |
| Polyisocyanate component | (NCO %) | (31%) | (31%) | (31%) | (31%) |
| | (NCO INDEX) | (57) | (63) | (69) | (57) |

| | | | | |
|---|---|---|---|---|
| Relationship between panel thickness | Perpendicular | Perpendicular | Perpendicular | Parallel |
| direction and foamed direction of cells in | | | | |
| foam | | | | |
| Foam density (kg/m³) | 7.6 | 7.5 | 9.8 | 6.0 |
| Thermal conductivity (mW/m · K) | 37.5 | 39.1 | 41.8 | 40.5 |
| in thickness direction | | | | |
| Foamed state | ◯ | ◯ | X | ◯ |

From Table 1, it is understood that the polyurethane foam panels of Examples 1 and 2 were low in density, low in brittleness, and excellent in heat insulating performance in the thickness direction. By contrast, the polyurethane foam panel of Comparative Example 1 was shrunken since foaming gas in the foam was released in a large quantity. Furthermore, cell roughness was generated and the brittleness was high. The heat insulating performance was also deteriorated in the thickness direction. The polyurethane foam panel of Comparative Example 2 was worse in heat insulating performance in the thickness direction than Example 1 although the two were produced from the same polyol composition as a raw material.

Next, a foam sample of 5 cm square was produced from the polyurethane foam produced using the polyol composition according to Example 1 as a raw material. This was compressed into a 90%-shape (compressed by 10%) in the T direction (parallel to the foamed direction of the foam cells), and in the W direction (perpendicular to the foamed direction of the foam cells). The recovery percentage thereof was measured. As a result, the foam was recovered into a 99.0%-shape in the T direction while recovered into a 98.2%-shape in the W direction. It is therefore understood that the polyurethane foam panel according to the present invention is high in recovery percentage and excellent in flexibility.

### (Preparation of Polyol Compositions)

Polyol compositions were each prepared in accordance with a blend composition described in Table 1. Details of individual components in Table 2 are as follows:

(1) Polyol Compounds

Polyether polyol (A)-1: trade name “EXCENOL-820” (manufactured by Asahi Glass Co., Ltd.), which is a polyether polyol (weight-average molecular weight=4900, and hydroxyl value (OHV)=34 mgKOH/g) obtained by using glycerin as an initiator and addition-polymerizing ethylene oxide and propylene oxide thereto.

Polyether polyol (A)-2: trade name “EXCENOL-230” (manufactured by Asahi Glass Co., Ltd.), which is a polyether polyol (weight-average molecular weight=3000, and hydroxyl value (OHV)=56 mgKOH/g) obtained by using glycerin as an initiator and addition-polymerizing ethylene oxide and propylene oxide thereto.

Polyether polyol (A)-3: trade name “EXCENOL-851” (manufactured by Asahi Glass Co., Ltd.), which is a polyether polyol (weight-average molecular weight=7000, and hydroxyl value (OHV)=25 mgKOH/g) obtained by using glycerin as an initiator and addition-polymerizing ethylene oxide and propylene oxide thereto.

Short glycol (B)-1: diethylene glycol (DEG) (molecular weight=106, and hydroxyl value (OHV)=1058 mgKOH/g, manufactured by Nacalai Tesque, Inc.)

Short glycol (B)-2: glycerin (Gly) (molecular weight=92, and hydroxyl value (OHV)=1829 mgKOH/g, manufactured by Nacalai Tesque, Inc.)

Polyether polyol (C): trade name “T-3000S” (manufactured by Mitsui Chemicals, Inc.), which is a polyether polyol (weight-average molecular weight=3000, and hydroxyl value=56 mgKOH/g) obtained by using glycerin as an initiator and addition-polymerizing only propylene oxide thereto.

(2) Flame retardant: trade name “TMCPP” (manufactured by Daihachi Chemical Industry Co., Ltd.)

(3) Foam stabilizer: silicone type nonionic surfactant, trade name “SF-2938F” (manufactured by Dow Corning Toray Co., Ltd.)

(4) Catalysts

Catalyst-1: tertiary amine catalyst, trade name “TOYOCAT-ET” (manufactured by Tosoh Corporation)

Catalyst-2: N,N-dimethylaminoethoxyethanol, trade name “KAO No. 26” (manufactured by Kao Corporation)

### (Panel Evaluation)

### Examples 3 to 5

A foaming stock-solution composition was prepared (in each of these examples). This contained a polyol composition adjusted into a formulation shown in Table 2, and a polyisocyanate component (c-MDI (“Sumidur 44V-10”, manufactured by Sumika Bayer Urethane Co., Ltd.; NCO %: 31%) was used, and the isocyanate index (NCO index) is shown in Table 2). The foaming stock-solution composition was injected to the bottom surface X of the mold (longitudinal-direction-a-length: 1820 mm, width-direction-b-length: 400 mm, and thickness-direction-c-length: 100 mm) illustrated in FIG. 1 from the mixing head 1. Thereafter, the foaming stock-solution composition was caused to undergo reaction to produce a polyurethane foam panel having substantially the same shape as the internal space of the mold, and having a thickness direction substantially perpendicular (90°) to the foamed direction of cells in the foam. Results are shown in Table 2. Methods for measuring the weight-average molecular weight, the foam density, and the thermal conductivity thereof, respectively, are as described above.

[Fitting Workability of Each of Polyurethane Foam Panels into Predetermined Shape]

When any one of the panels, the width of which was 400 mm, was compressed by 10% so that the panel was able to be easily fitted into a width of 360 mm, the polyurethane foam panel was judged to be good (circular sign in the table) in fitting workability because the panel was considered to have the flexibility to a predetermined width.

TABLE 2

| | | OHV | | | |
|---|---|---|---|---|---|
| Blend agents | | (mgKOH/g) | Example 3 | Example 4 | Example 5 |
| Polyether polyol (A)-1 | EX-820 | 34 | 70 | 20 | — |
| Polyether polyol (A)-4 | EX-850 | 25 | — | — | 80 |
| Polyether polyol (C) | T-3000S | 56 | — | 70 | — |
| Short glycol (B)-1 | DEG | 1058 | 30 | 10 | 20 |
| Flame retardant | | | 50 | 40 | 50 |
| Foam stabilizer-1 | | | 5.0 | 5.0 | 5.0 |
| Catalyst-1 | | | 3.0 | 3.0 | 3.0 |
| Catalyst-2 | | | 3.0 | 3.0 | 3.0 |
| Water | | | 80.0 | 60.0 | 70.0 |
| Polyisocyanate | | (NCO %) | (31%) | (31%) | (31%) |
| component | | (NCO INDEX) | 27 | 22 | 30 |

| | | | |
|---|---|---|---|
| Foam density (kg/m³) | 6.9 | 9.8 | 7.0 |
| Thermal conductivity (mW/m · K) | 38.0 | 38.5 | 38.2 |
| Fitting workability into predetermined shape | ◯ | ◯ | ◯ |

From Table 2, it is understood that the polyurethane foam panels of Examples 3 to 5 were low in density, law in brittleness, and excellent in heat insulating performance in the thickness direction. It is also understood that these examples were excellent in fitting workability since these had an excellent flexibility.

1. A polyurethane foam panel, obtained by mixing a polyol composition comprising polyol compounds, and water as a blowing agent with a polyisocyanate component to react therewith,
wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250,
the water is contained in an amount of 20 to 100 parts by weight for 100 parts by weight of the polyol compounds, and
the thickness direction of the polyurethane foam panel is substantially perpendicular to the foamed direction of cells in the foam.

2. A polyurethane foam panel, obtained by mixing a polyol composition comprising polyol compounds, and water as a blowing agent with a polyisocyanate component to react therewith,
wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250,
the water is contained in an amount of 20 to 100 parts by weight for 100 parts by weight of the polyol compounds, and
at the time of mixing and reacting the polyol composition and the polyisocyanate component with each other, the isocyanate index of the component is 30 or less.

3. The polyurethane foam panel according to claim 2, wherein the thickness direction of the polyurethane foam panel is substantially perpendicular to the foamed direction of cells in the foam.

4. The polyurethane foam panel according to claim 1, wherein the polyol compounds contain the polyether polyol (A) in an amount of 10 to 80 parts by weight for 100 parts by weight of the polyol compounds, and the short glycol (B) in an amount of 10 to 60 parts by weight therefor.

5. The polyurethane foam panel according to claim 1, wherein the polyol compounds further comprise a polyether polyol (C) which is a polymer made from propylene oxide and has an average functional group number of 2 to 4 and a weight-average molecular weight of 3000 to 5000.

6. A method for producing a polyurethane foam panel, using, as a raw material, a foaming stock-solution composition comprising not only a polyol composition comprising polyol compounds and water as a blowing agent, but also a polyisocyanate component,
the method comprising an injecting step of injecting the foaming stock-solution composition into a mold having a longitudinal direction, a width direction and a thickness direction to locate the bottom surface of the foaming stock-solution composition onto side surfaces of the mold that extend in the longitudinal and thickness directions, and
further comprising, after the injecting step, a reaction step of causing the foaming stock-solution composition to undergo reaction,
wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250, and
the water is contained in an amount of 20 to 100 parts by weight for 100 parts by weight of the polyol compounds.

7. A method for producing a polyurethane foam panel, using, as a raw material, a foaming stock-solution composition comprising not only a polyol composition comprising polyol compounds and water as a blowing agent, but also a polyisocyanate component,
wherein the polyol compounds comprise a polyether polyol (A) which is a polymer made from an alkylene oxide and has an average functional group number of 2 to 4 and a weight-average molecular weight of 3000 to 8000, and a short glycol (B) having a molecular weight less than 250,
the water is contained in an amount of 20 to 100 parts by weight for 100 parts by weight of the polyol compounds, and
at the time of mixing and reacting the polyol composition and the polyisocyanate component with each other, the isocyanate index of the component is 30 or less.

8. The method for producing a polyurethane foam panel according to claim 7, comprising an injecting step of injecting the foaming stock-solution composition into a mold having a longitudinal direction, a width direction and a thickness direction to locate the bottom surface of the foaming stock-solution composition onto side surfaces of the mold that extend in the longitudinal and thickness directions, and
further comprising, after the injecting step, a reaction step of causing the foaming stock-solution composition to undergo reaction.

9. The method for producing a polyurethane foam panel according to claim 6, wherein the polyol compounds contain the polyether polyol (A) in an amount of 10 to 80 parts by weight for 100 parts by weight of the polyol compounds, and the short glycol (B) in an amount of 10 to 60 parts by weight therefor.

10. The method for producing a polyurethane foam panel according to claim 6, wherein the polyol compounds further comprise a polyether polyol (C) which is a polymer made from propylene oxide and has an average functional group number of 2 to 4 and a weight-average molecular weight of 3000 to 5000.

11. The polyurethane foam panel according to claim 2, wherein the polyol compounds contain the polyether polyol (A) in an amount of 10 to 80 parts by weight for 100 parts by weight of the polyol compounds, and the short glycol (B) in an amount of 10 to 60 parts by weight therefor.

12. The polyurethane foam panel according to claim 2, wherein the polyol compounds further comprise a polyether polyol (C) which is a polymer made from propylene oxide and has an average functional group number of 2 to 4 and a weight-average molecular weight of 3000 to 5000.

13. The method for producing a polyurethane foam panel according to claim 7, wherein the polyol compounds contain the polyether polyol (A) in an amount of 10 to 80 parts by weight for 100 parts by weight of the polyol compounds, and the short glycol (B) in an amount of 10 to 60 parts by weight therefor.

14. The method for producing a polyurethane foam panel according to claim 7, wherein the polyol compounds further comprise a polyether polyol (C) which is a polymer made from propylene oxide and has an average functional group number of 2 to 4 and a weight-average molecular weight of 3000 to 5000.
